(19) United States
(12) Patent Application Publication
(10) Pub. No.: US 2002/0160179 A1
(43) Pub. Date: Oct. 31, 2002

(54) Paperboard

(75) Inventors: Nipun Marwah, Mt. Pleasant, SC (US); David R. B. Walker, Charleston, SC (US); Ramazan Benrashid, Mt. Pleasant, SC (US); Louie R. Hancock, Summerville, SC (US); Harry W. Robertson IV, Covington, VA (US); Bruce T. Wright, Charleston, SC (US)

Correspondence Address: Terry B. McDaniel, Westvaco Corporation, 5255 Virginia Avenue, P. O. Box 118005, Charleston, SC, 29423-8005, US

(73) Assignee: Westvaco Corporation, New York (US)

(21) Appl. No.: 10/074,729

(22) Filed: Apr. 23, 2002

Related U.S. Application Data
(62) Division of application No. 09/575,628, filed on May 20, 2000.

(51) Int. Cl. D21F 11/00; D21H 23/00; B32B 5/16

(52) U.S. Cl. 428/323; 162/158

(57) ABSTRACT

The present invention discloses an improved paperboard for use in food or non-food products. The disclosed board utilizes a novel method of applying adsorptive material to packaging paperboard to overcome emissions (by adsorption thereof) of odiferous manufacturing components from the board, as well as any offensive odors emitted by contents of packages made from the board. The disclosed approach utilizes known adsorptive materials, which are applied to the pulp stock in such a manner that it does not negatively impact either the appearance or physical attributes of the finished board.

### BACKGROUND OF THE INVENTION

1. Field of the Invention

The present invention relates to a novel paperboard and method of producing paperboard, which contains an adsorptive material to effectively address the odor emission problem associated with such board. More particularly, the invention relates to a method of applying such adsorptive material in unbleached board in a way that does not negatively impact the appearance or physical attributes of the board.

2. Description of Related Art (Including Information Disclosed Under 37 CFR 1.97 and 37 CFR 1.98)

Various paperboard-based structures are utilized to store and/or serve liquid or solid, food or non-food, products. The odor issue related to paperboard, however, could have a negative impact for uses that are sensitive to inherent board odor, resulting from pulping chemicals, by-products, and processing additives. Various approaches have been utilized or reported to address the odor issue related to paperboard in general, in these structures. Some of these approaches are designed to combat odors generated by the material being packaged, rather than the odor of the board itself.

A widely known and used approach is to coat the paper-based structure with various barrier and sealant materials. One basic structure utilizes a three-layer laminate wall structure. The laminate comprises of a paperboard substrate coated on both sides by a layer of low-density polyethylene. A second widely known structure uses a five-layer laminate wall structure. This structure is comprised of paperboard substrate, a layer of low density polyethylene coated onto the foil layer rendering the structure heat sealable. In addition, various other barrier materials have been used to combat the transfer of various gases, light, and flavors into and out of the container. These approaches are for specific packages and add substantial cost to the package. Other approaches to address board odor involve using odor masking agents and adsorbents.

One common adsorbent is activated carbon. Adsorptive characteristics of activated carbon are well known. Carbon has been proposed to be used as blend in polyethylene where it could be coated onto the board to adsorb odors. Vinegar/carbon blends also have been suggested. These “coating” approaches with carbon might work, but they negatively impact the appearance of the board. Also, as the carbon is black, the impact on aesthetics of the board is highly undesirable.

Specific U.S. patents describing some of the above-discussed materials and methods include:

| U.S. Pat. No. | Title |
|---|---|
| 4,212,852 | “Method of Deodorizing Gas Containing Hydrogen |
| | Sulfide And Ammonia And/Or Amines” |
| 4,235,027 | “Laminated Insole” |
| 4,256,728 | “Deodorization Method” |
| 4,337,276 | “Method for Storing Produce and Container and |
| | Freshness Keeping Agent Therefor” |
| 4,443,482 | “Buttered Table Syrup in Polyolefin Bottle” |
| 4,517,308 | “Method of Producing a Sorptive Body, Particularly for |
| | Eliminating Odors, Air Freshening, Etc. and The |
| | Resultant Product” |
| 4,528,281 | “Carbon Molecular Sieves and a Process for Their |
| | Preparation and Use” |
| 4,818,524 | “Deodorizing Compositions” |
| 4,840,823 | “Plastic Film Packaging Material” |
| 4,919,925 | “Deodorant, Deodorizing Composite Material, |
| | Deodorizing Resin Composition, Deodorizing Resin |
| | Articles and Deodorizing Foam” |
| 4,931,360 | “Deodorizing Sheet with a Deodorizing Coating |
| | Formulation” |
| 4,938,957 | “Deodorant Composition and Use Thereof” |
| 5,009,887 | “Deodorant Composition in the Form of a Gel” |
| 5,693,385 | “Odor Sorbing Packaging Material” |

An object of the present invention is to overcome the deficiencies of the conventional paperboard based packages and containers by incorporating into the board an adsorptive material, primarily activated carbon, in a unique way, which improves the odor of the board without negatively impacting the appearance or the quality of the board.

Another object of the present invention is to provide odor improved board for all sizes and types of liquid or solid, food or non-food containers, and microwaveable and ovenable packaging, as required by the converter or packager to improve the market potential of the product.

Another object of this invention is to utilize this board in making liquid packaging board which may have multiple barrier layers such as aluminum foil, polyethylene terepthalate, glycol-modified PET, acid-modified PET, ethylene vinyl alcohol copolymer, polyvinyl alcohol, polybutylene terphthalate, vinylidene chloride copolymer, polyvinyl chloride polymer, vinyl chloride copolymer, polyvinyl chloride polymer, vinyl chloride copolymer, polyamide polymer, polyamide copolymer or polycarbonate polymer.

### SUMMARY OF THE INVENTION

A preferred embodiment of the present invention reveals the use of an adsorptive material in the board for use in making food or non-food, liquid or solid container or package to improve inherent board odor and improve the products' market appeal.

A multi-layered paperboard composite embodying the attributes of the invention can be produced by applying granular, pelletized, fiberized, powdered, or any other form of activated carbon in between the two layers of paperboard, or on a side that will be on the inside of the package made from the paperboard, in such as way that the visual appearance and quality (i.e., physical strength properties) are not negatively impacted. The paperboard which contains the activated carbon can produce various kinds of packages and containers, including paper cups and plates, which overcome the odors associated with paperboard. In addition, as a result of the method of adding this adsorbent material into the paperboard, the paperboard exhibits desirable aesthetic appearance and excellent physical characteristics. This paper/paperboard will also have the capability to adsorb any off-odors from printing inks and varnishes as well. Finally, the resultant package made from the invention paperboard will have the capability to adsorb any offensive odors emitted by the packaged contents.

### BRIEF DESCRIPTION OF THE DRAWINGS

FIG. 1 is a cross-sectional view of a multi-layer paperboard exhibiting a thin top layer and a thick bottom layer.

FIG. 2 is a cross-sectional view of a multi-layer paperboard exhibiting a thin top layer, a thick bottom layer, and an adsorbent material buried within the bottom thick layer and under the top thin layer.

FIG. 3 is a cross-sectional view of a single layer paperboard without added adsorbent material.

FIG. 4 is a cross-sectional view of a single layer paperboard containing an added adsorbent material buried within the bottom single layer.

### DESCRIPTION OF THE PREFERRED EMBODIMENT(S)

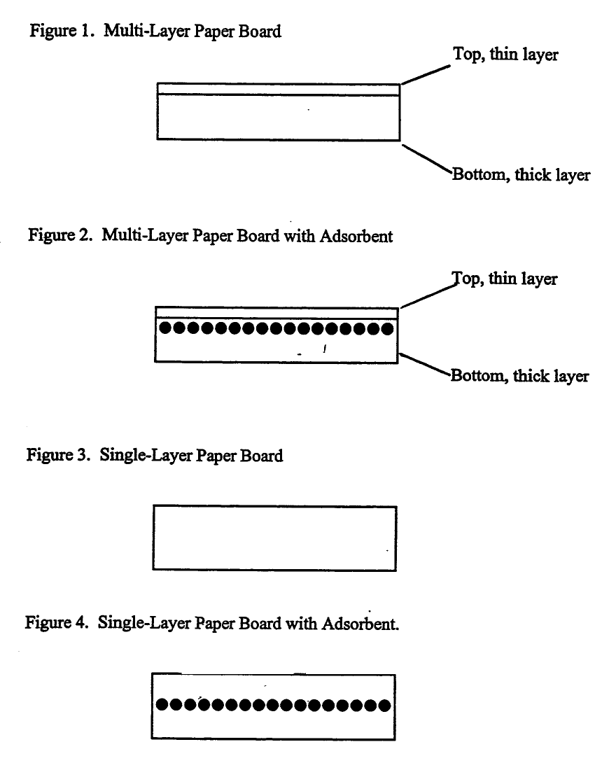

The invention is preferentially described with reference to the drawings. FIG. 1 depicts a conventional multi-ply paperboard wherein the paperboard has two plies with a thin top ply (about 15% of the total board weight) and a thick bottom ply. This board normally is rated between 5-7 on taste and odor panel test. (The panel test employed in the examples to follow is described below.) FIG. 2 depicts a similar board as in FIG. 1, with the exception that adsorptive material has been added between the two plies in such a way that internal bonding between the two layers remains acceptable and the visual appearance of the board is not impaired. The adsorptive material can be applied by using various techniques such as, but not limited to, curtain coaters, conventional sprayers, air-atomized sprayers, and direct addition to the pulp stock. The adsorptive materials may be any shape of activated carbon or charcoal or equivalent thereof, as known to those skilled in the art.

Panel Test Method:

A 3 gram board sample is cut into 1 square inch pieces and placed in a 1-liter wide mouth mason jar. A 100 ml beaker filled with bottled drinking water is placed into the jar without covering the board pieces. The jar is then sealed and left at ambient temperature for 24 hours. The water in the beaker is tasted by a sensory panel and compared for “degree of difference” against the control water taken directly from the bottle. The samples are rated on a scale of 1 through 7, with 1 through 3 being “acceptable,” 4 being “marginal,” and 5 through 7 being “unacceptable.”

Application Test Method:

Spray Header—A spray header made up of air atomizer nozzles was used to spray a carbon slurry at 5% solids. For a multi-ply sheet, the header was placed on the machine such that carbon slurry would fall onto the wet portion [consistency of 5-10%] of the lower sheet as it is being formed. This results in carbon getting sucked into the lower layer rather than sitting on top of the layer. A similar approach was used on a single ply.

Curtain Coater—A curtain coater, instead of spray header was used to apply the carbon slurry in a similar fashion described above.

### EXAMPLE 1

The first set of experiments was conducted using deionized (DI) water to dilute the previously dewatered secondary and primary machine chest pulps. The carbon slurry was also made with DI water and sprayed in between the two plies of KRAFTPAK® sheets (manufactured by Westvaco Corporation) made on the Dynamic Sheet Former (DSF). The carbon dosages tested were 0.1, 0.2, 0.5, and 1 percent (by weight). Table I shows the panel results on these samples over a five-month period. Carbon application levels of 0.5% and 1% gave excellent results throughout the five-month test period. The corresponding ratings were 2 and 3, respectively. The control was better than expected at 4, probably due to the use of DI water to dilute pulps. Thus, subsequent evaluations were done with primary and secondary head box samples without dewatering.

TABLE I
Taste and Odor Panel Results of Carbon-Treated Sheets (Pulps Diluted
with DI water)

| | Carbon, | Rating | Rating | Rating | Rating | Rating |
|---|---|---|---|---|---|---|
| Sample ID | % | Day 1 | Day 4 | Day 7 | Day 11 | Day 105 |
| 7805-30 | 0 | 4 | 3 | 4 | 6 | 4 |
| 7805-30-4 | 0.1 | 3 | 2 | — | 4 | — |
| 7805-30-2 | 0.2 | 2 | 2 | 2 | 2 | 5 |
| 7805-30-3 | 0.5 | 2 | 2 | 2 | 2 | 2 |
| 7805-30-1 | 1.0 | 2 | 2 | 2 | 2 | 3 |
| water | no paper/ | 1 | 2 | 2 | 2 | 1 |
| blank | carbon | | | | | |

### EXAMPLE 2

The same experiments were repeated using primary and secondary headbox samples. Since headbox samples are at about 0.5% consistency (in white water or mill process water), no additional water was required for dilution. Carbon slurries were prepared in DI water. The results are summarized in Table II.

TABLE II
Panel Results of Carbon-Treated Sheets (Pulps Diluted with White Water)

| | Carbon | Rating | Rating | Rating | Rating |
|---|---|---|---|---|---|
| Sample ID | % | Day 1 | Day 7 | Day 14 | 5 Months |
| 7805-32 | 0 | 4 | 6 | 5 | 6 |
| 7805-32-4 | 0.1 | 2 | 6 | 6 | 7 |
| 7805-32-3 | 0.25 | 2 | 5 | 5 | 7 |
| 7805-32-2 | 0.5 | 2 | 3 | 5 | 6 |
| 7805-32-1 | 1.0 | 2 | 3 | 3 | 3 |
| water blank | no paper/ | 2 | 2 | 2 | 1 |
| | carbon | | | | |

The day 1-panel results looked good; however, the ratings tend to revert back to poor values in subsequent testing. Only the 1% carbon level maintained good ratings for up to a five-month period. These results indicate that the white water may have a negative impact on the carbon performance at the levels tested below 1.0%. At 1.0% carbon application, results were excellent and remained so even after the 5-month period.

### EXAMPLE 3

Laboratory experiments were conducted to see if microporous carbon would offer better efficiency with regard to improving taste and odor. Both microporous carbon (Pica's PW-2 carbon) and HIACT® carbon (obtained from Westvaco Corporation) were tested by spraying aqueous slurries prepared with each type of the activated carbons, between the two KRAFTPAK® plies in the Dynamic Sheet Former. In one case, 250 ppm hydrogen peroxide was added to the primary and secondary slurries prior to sheetmaking to see if additional benefits would be gained.

Clay addition to the secondary layer was tested to enhance brightness of the sheets. These laboratory-made handsheets were panel tested nine times over a period of seven months. The results are summarized in Table III. The carbon-treated sheets with either microporous or HIACT® carbons gave and maintained acceptable taste and odor for seven months to date. The average of nine panel tests over seven months showed the (carbonless) control at an unacceptable rating of 5.2, as compared to 2.3 for HIACT® activated carbon and 2.0 for microporous activated carbon inclusions. The presence of white water in pulp slurries did not have any significant impact on panel results at the carbon levels tested. Also, the addition of hydrogen peroxide into pulp/white water slurries did not provide any clear benefit, based on panel results.

The addition of 20% Fiberex clay was found to improve the GE brightness of a carbon-treated sheet from 17.5% to a GE brightness of 20.4%.

TABLE III
Panel Results of Carbon Treated Sheets

| | Water | Carbon %; | Peroxide | | Panel | Panel | Panel | Panel | Panel | Panel | Panel |
|---|---|---|---|---|---|---|---|---|---|---|---|
| | used | [on total | ppm, [on | | Rating | Rating | Rating | Rating | Rating | Rating | Rating |
| | to make | sheet wt. | total slurry | Bright. | Day 1 | Day 5 | Day 13 | Month 1 | Month 2 | Month 3 | Month 4 |
| Exp# | sheets | basis] | vol. basis] | % GE | 3/12 | 3/16 | 3/24 | 4/12 | 5/18 | 6/16 | 7/29 |
| 1. Control | WW | 0 | 0 | 18.1 | 7 | 5 | 6 | 6 | 6 | 5 | 2 |
| 2. Control | WW | 0 | 0 | 19.8 | 6 | 5 | 6 | 6 | 6 | 6 | 4 |
| | | | | w/20% | | | | | | | |
| | | | | clay | | | | | | | |
| 3. Control | WW | 0 | 250 | 18.1 | 6 | 4 | 5 | 6 | 7 | 6 | 5 |
| 4. Control | CW | 0 | 0 | 18.1 | 5 | 6 | 5 | 5 | 7 | 5 | 5 |
| Average | | | | | 6 | 5 | 5.5 | 6 | 6.5 | 5.5 | 4 |
| 5. Hiact-1A | WW | 1 | 0 | 17.5 | 2 | 2 | 1 | 3 | 2 | 2 | 1 |
| 6. Hiact-1B | WW | 1 | 250 | 17.5 | 3 | 2 | 2 | 4 | 1 | 3 | 1 |
| 7. Hiact-1C | WW | 1 | 0 | 20.4 | 5 | 2 | 4 | 4 | 5 | 3 | 2 |
| | | | | w/20% | | | | | | | |
| | | | | clay | | | | | | | |
| 8. Hiact-1D | CW | 1 | 0 | 18.0 | 2 | 2 | 1 | 2 | 3 | 2 | 1 |
| Average | | | | | 3 | 2 | 2 | 3.25 | 2.75 | 2.5 | 1.3 |
| 9. MP-2A | WW | 1 | 0 | 16.6 | 2 | 2 | 1 | 3 | 2 | 2 | 1 |
| 10. MP-2B | WW | 1 | 250 | 17.0 | 2 | 2 | 2 | 2 | 4 | 2 | 2 |
| 11. MP-2C | CW | 1 | 0 | 19.1 | 2 | 2 | 1 | 1 | 2 | 2 | 2 |
| Average | | | | | 2 | 2 | 1.3 | 2 | 2.7 | 2 | 1.7 |

Notes:
20% clay improved brightness of a 17.5% carbon treated sheet to 20.4%. Peroxide added to each [primary and secondary] pulp slurry at 50 C, 10 min.
MP = Micro porous Carbon [non Westvaco]; Hiact = Westvaco Carbon
WW = White (treated mill) Water
CW = City Water

### EXAMPLE 4

Paper Machine trials were run using an air atomizer and a curtain coater. These trials were successful in providing uniform carbon coverage without negatively impacting the appearance or quality of the sheet. The panel results on these mill-produced samples were found to be acceptable (in the range of 1 to 3). The carbon containing paperboard was successfully converted into prototype products. Blind panel tests on prototype products gave excellent taste and odor results as compared to the control (Table IV).

TABLE IV
Taste and Odor Test Results
Blind Tests in Collaboration With Sensory Directions

| | | | Taste and Odor | | Taste and Odor | |
|---|---|---|---|---|---|---|
| | | | Test w/ hot H20 | | Test w/ hot coffee | |
| | Standard | | [c] | | [c] | |
| | Panel | Smell | smell | taste | smell | taste |
| | Test | Test | @ | @ | @ | @ |
| Cup Type | [a] | [b] | 10 min. | 20 min. | 10 min. | 20 min. |
| Bleached | 2 [d] | 5 [e] | 3 | 4 [e] | 3 | 3 [e] |
| Kraft, | 6 | 6 | 4 | 5 | 4 | 3 |
| Control | | | | | | |
| Kraft w/ | 4 | 3 | 2 | 3 | 3 | 3 |
| 0.75% | | | | | | |
| carbon | | | | | | |
| Kraft w/ | 3 | 2 | 3 | 3 | 2 | 4 |
| 0.75% | | | | | | |
| carbon | | | | | | |
| and | | | | | | |
| bleached | | | | | | |
| bottom | | | | | | |
| Kraft w/ | 2 | 2 | 2 | 3 | 2 | 3 |
| 1% carbon | | | | | | |

[a]cup clippings placed at the bottom of a jar containing a beaker full of water. This set up is left enclosed for 24 hours prior to tasting water for degree of difference from the control water.
[b]cups are rated based on smell.
[c]Test was conducted using 180° F. water or coffee. Smell test was conducted at 10 minutes after hot beverage was placed into the cups [the first value in the column]. A taste test was conducted after 20 minutes [second value in the column].
[d]Chinet bleached cups.
[e]Commercial bleached cups from coffee shop.

### EXAMPLE 5

The effectiveness of a combination of activated carbon, hydrogen peroxide, and an antioxidant in improving KRAFTPAK® taste and odor was investigated. The antioxidants tested were commercially available butylated hydroxy toluene (BHT) dispersion and Oxytrap RC 91. Taste and odor ratings are shown in Table V. Oxytrap RC 91 showed the best results after a two-week testing.

TABLE V

| Sample | Activated Carbon/ | | Brightness, | Taste and Odor | |
|---|---|---|---|---|---|
| ID | Zeolite | Type of Water | % GE | Rating | Comments |
| 7772-62 C1 | — | — | 10.7 | 6 | — |
| 7772-62 C2 | — | — | 12.8 | 7 | wash primary layer with 500 |
| | | | | | ml DI water |
| 7772-62-1 | 1% Carbon | WW | 10.9 | 3(2/3) | Sandwich |
| | | | | 4(2/17) | |
| 7772-62-2 | 1% Carbon | WW | 11.2 | 4(2/3) | 4#/ton Oxytrap |
| | | | | 3(2/17) | |
| 7772-62-3 | 1% Carbon | WW | 12.2 | 3(2/3) | 4#/ton BHT |
| | | | | 5(2/17) | |
| 7772-62-7 | 1% Carbon | WW neutralized with | 6.9 | 3(2/3) | Sandwich |
| | | 500 ppm H₂O₂ | | 6(2/17) | |
| 7772-52-1 | 1% Carbon | WW | — | 2(12/11) | Sandwich |
| | | | | 3(2/3) | |
| | | | | 4(2/17) | |

WW = white water from mill. Number in parenthesis is the date sample was tested

### EXAMPLE 6

Different dispersing agents were used for a better carbon dispersion. KRAFTSPERSE® 1251, KRAFTSPERSE® 25M, Versa TL-70, and Ultrazine NA were used to disperse carbon. In-house taste and odor ratings are shown in Table VI. Ultrazine NA showed the best results. A better dispersed carbon slurry in combination with proper spray nozzle design would help further in achieving a uniform carbon application across the sheet.

TABLE VI
Impact of Carbon Dispersion Aids on Taste and Odor

| | | | | | | | Taste and |
|---|---|---|---|---|---|---|---|
| | KRAFTSPERSE | Fiberex % in | Versac | | KRAFTSPERSE | Brightness | Odor |
| ID | 1251 | Secondary | TL-70 | Ultrazine NA | 25 M | % GE | Rating |
| Control I | | — | | | — | 14.4 | 4 |
| Control II | | — | | | — | 12.2 | 5 |
| Control III | — | — | — | — | — | 11.3 | 3 |
| Condition 1 | 8% | — | — | — | | 11.7 | 3 |
| | (carbon weight) | | | | | | |
| Condition 1A | 8% | 5 | | | | 13.3 | — |
| | (carbon weight) | | | | | | |
| Condition 1B | 8% | 10 | | | | — | |
| | (carbon weight) | | | | | | |
| Condition 2 | — | — | 8% | — | — | 11.8 | 4 |
| | | | (carbon weight) | | | | |
| Condition 3 | — | — | — | 8% | — | 10 | 2 |
| | | | | (carbon weight) | | | |
| Condition 4 | — | — | — | — | 8% | 12 | — |
| | | | | | (carbon weight) | | |

Other general methods, materials, and finished products may be suggested in the instant disclosure to those skilled in the art that may differ somewhat from the specific methods, materials, and finished products reported herein. Such slight deviations are considered to be within the subject matter of this invention and within the purview of the following claims.

What is claimed is:

1. A paperboard useful in paper-based packages or containers for holding liquids or solids comprising a sub-surface layer of an adsorbent material to reduce inherent board odor with essentially no reduction in strength of the parent board.

2. The paperboard of claim 1 wherein the adsorbent is selected from the group consisting of activated carbon, zeolite, and cyclodextrins.

3. The paperboard of claim 2 wherein the adsorbent is an activated carbon selected from the group consisting of granular, powdered, pelletized, and fiberized activated carbons, and combinations thereof.

4. The paperboard of claim 2 wherein the adsorbent is present in the board at a concentration above 0.1 weight % of the board.

5. The paperboard of claim 1 wherein the adsorbent is applied to the board using an air atomized spray.

6. The paperboard of claim 1 wherein the adsorbent is applied to the board using equipment selected from the group consisting of a curtain coater, a size press, a blade coater, and a headbox.

7. The paperboard of claim 1 further comprised of a single layer of paperboard.

8. The paperboard of claim 1 further comprising multiple layers of paperboard including a topmost layer and a layer positioned immediately below the topmost layer.

9. The paperboard of claim 8 wherein the sub-surface layer of an adsorbent material is located in the layer positioned immediately below the topmost layer.

10. A method of preparing paperboard produced from pulp stock and useful in paper-based packages or containers for holding liquids or solids comprising adding an adsorbent material to the pulp stock to provide a sub-surface layer of said adsorbent material within the paperboard.

11. The method of claim 10 wherein the adsorbent addition to the paperboard adsorbs the undesired odors emitted from polymer- and pigment-based additives employed in the conversion of the paperboard into a packaging or a container product.

12. The method of claim 10 wherein the adsorbent is added in combination with an oxidant.

13. The method of claim 12 wherein the oxidant is hydrogen peroxide.

14. The method of claim 10 wherein the adsorbent is added in combination with an antioxidant.

15. The method of claim 10 wherein the paperboard is formed of a single layer of the pulp stock.

16. The method of claim 10 wherein the paperboard is formed of multiple layers of the pulp stock including a topmost layer and a layer positioned immediately below the topmost layer.

17. The method of claim 16 wherein the sub-surface layer of the adsorbent material is added to the pulp stock which forms the layer positioned immediately below the topmost layer.
